(19) United States
(12) Patent Application Publication
(10) Pub. No.: US 2007/0124567 A1
(43) Pub. Date: May 31, 2007

(54) Processor system

(75) Inventors: Aki Tomita, Tachikawa (JP); Hidetaka Aoki, Tokyo (JP); Naonobu Sukegawa, Inagi (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/357,972

(22) Filed: Feb. 22, 2006

(30) Foreign Application Priority Data
Nov. 28, 2005 (JP) JP2005-341339

(51) Int. Cl. G06F 15/00

(52) U.S. Cl. 712/220

(57) ABSTRACT

A processor system capable of improving usability and performance of an on-chip heterogeneous multiprocessor is provided. The processor system has a processor and a memory, the processor including one control unit that reads a program, a plurality of arithmetic units that transmit a SIMD instruction of the program read by the control unit, and a shared cache capable of storing the program read by the control unit from the memory and allowing the control unit and the plurality of arithmetic units to read and write data. An instruction transmitted from the control unit to the plurality of arithmetic units specifies, in a process where the plurality of arithmetic units execute instructions, whether, until receiving an external signal from an arithmetic unit different from the arithmetic unit that is executing the instruction, execution of the instruction is to be suspended.

### CROSS-REFERENCE TO RELATED APPLICATION

The present application claims priority from Japanese patent application No. JP 2005-341339 filed on Nov. 28, 2005, the content of which is hereby incorporated by reference into this application.

### BACKGROUND OF THE INVENTION

The present invention relates to a processor system in which a memory and a processor are connected to each other over an internal network, and, more particularly, to a technology effectively applied to an on-chip heterogeneous multiprocessor.

In the field of High Performance Computing (HPC), for example, for the purpose of achieving a dramatically high price/performance ratio, needs for mounting accelerators (arithmetic units) have arisen. To fulfill such needs, a technology as disclosed in Patent Document 1 (Japanese Patent Laid-Open Publication No. 2003-281107) has been suggested.

This Patent Document 1 discloses a technology in which an AP equivalent to a control unit and APUs equivalent to arithmetic units are independently provided and an APU remote procedure call command is used so as to control processes by the APUs. Furthermore, in this Patent Document 1, in software cells equivalent to a program, a minimum number of APUs required for executing the cells are provided, and each APU is configured to specify an APU program to be executed.

### SUMMARY OF THE INVENTION

However, in a numerical computation program, a control unit generally instructs a plurality of arithmetic units to execute the same arithmetic process, and then the control unit summarizes the execution results of the respective arithmetic units. Unlike the technology disclosed in the above Patent Document 1, it is unnecessary to allow each APU to execute the different program. To the contrary, if each APU has to specify the program to be executed, usability will be impaired.

Still further, the technology disclosed in the above Patent Document 1 does not necessarily assume the case in which a plurality of APUs execute the same process. Therefore, no measures have been devised against deterioration in performance due to simultaneous execution of memory accesses by a plurality of APUs. On the other hand, to increase effective performance by mounting arithmetic units, it is required to transfer data appropriate to the arithmetic performance of the respective arithmetic units. If such prevention of concentration of the memory accesses, which is required to be performed based on knowledge about detailed operations of hardware, is left entirely to users, deterioration of performance and usability will be caused.

Therefore, the present invention solves the problems as described above, and an object of the present invention is to provide a processor system capable of improving usability and performance of an on-chip heterogeneous multiprocessor.

The above or other objects and novel features will become apparent from the description of the present specification and the accompanying drawings.

Outlines of representative ones of the inventions disclosed in the present application will be briefly described as follows.

The present invention is applied to a processor system including: a memory having stored therein a program and data; a processor executing the program using the data; and an internal network over which the memory and the processor are connected to each other, and has the following features.

The processor includes one control unit that reads the program, a plurality of arithmetic units that transmit a SIMD instruction of the program read by the control unit, and a shared cache capable of storing the program read by the control unit from the memory and allowing the control unit and the plurality of arithmetic units to read and write data. In particular, an instruction transmitted from the control unit to the plurality of arithmetic units specifies, in a process where the plurality of arithmetic units execute instructions, whether, until receiving an external signal from an arithmetic unit different from the arithmetic unit that is executing the instruction, execution of the instruction is to be suspended. Also, when an arithmetic unit resumes a process of the instruction whose execution has been suspended, an external signal is issued to the control unit or the different arithmetic unit.

Effects obtained by representative ones of the inventions disclosed in the present application will be briefly described as follows.

According to the present invention, it is possible to provide a processor system capable of improving usability and performance of an on-chip heterogeneous multiprocessor.

### DESCRIPTION OF THE DRAWINGS

FIG. 1 is a view showing an example of a configuration of a multiprocessor system according to one embodiment of the present invention;

FIG. 2 is a view showing an example of a configuration of a control unit and arithmetic units in the multiprocessor system according to one embodiment of the present invention;

FIG. 3 is a view showing an example of a flow of an instruction executing process by the control unit in the multiprocessor system according to one embodiment of the present invention;

FIG. 4 is a view showing an example of a process flow of an arithmetic unit execution managing section in the multiprocessor system according to one embodiment of the present invention;

FIG. 5 is a view showing an example of a flow of an instruction complete process of an arithmetic unit execution managing section in the multiprocessor system according to one embodiment of the present invention;

FIG. 6 is a view showing an example of a configuration of a main arithmetic unit in the multiprocessor system according to one embodiment of the present invention;

FIG. 7 is a view showing an example of a process flow of the main arithmetic unit in the multiprocessor system according to one embodiment of the present invention;

FIG. 8 is a view showing an example of a configuration of a sub-arithmetic unit in the multiprocessor system according to one embodiment of the present invention;

FIG. 9 is a view showing an example of a process flow of the sub-arithmetic unit in the multiprocessor system according to one embodiment of the present invention;

FIG. 10 is a view showing an example of a configuration of a completed sub-arithmetic unit in the multiprocessor system according to one embodiment of the present invention;

FIG. 11 is a view showing an example of a process flow of the completed sub-arithmetic unit in the multiprocessor system according to one embodiment of the present invention; and

FIG. 12 is a view showing an example of instruction format transmitted from the control unit to the arithmetic units in the multiprocessor system according to one embodiment of the present invention.

### DESCRIPTION OF THE PREFERRED EMBODIMENTS

Hereinafter, embodiments of the present invention will be detailed based on the accompanying drawings. Note that throughout all the drawings for describing the embodiments, the same members are denoted in principle by the same reference numeral and the repetitive description thereof will be omitted.

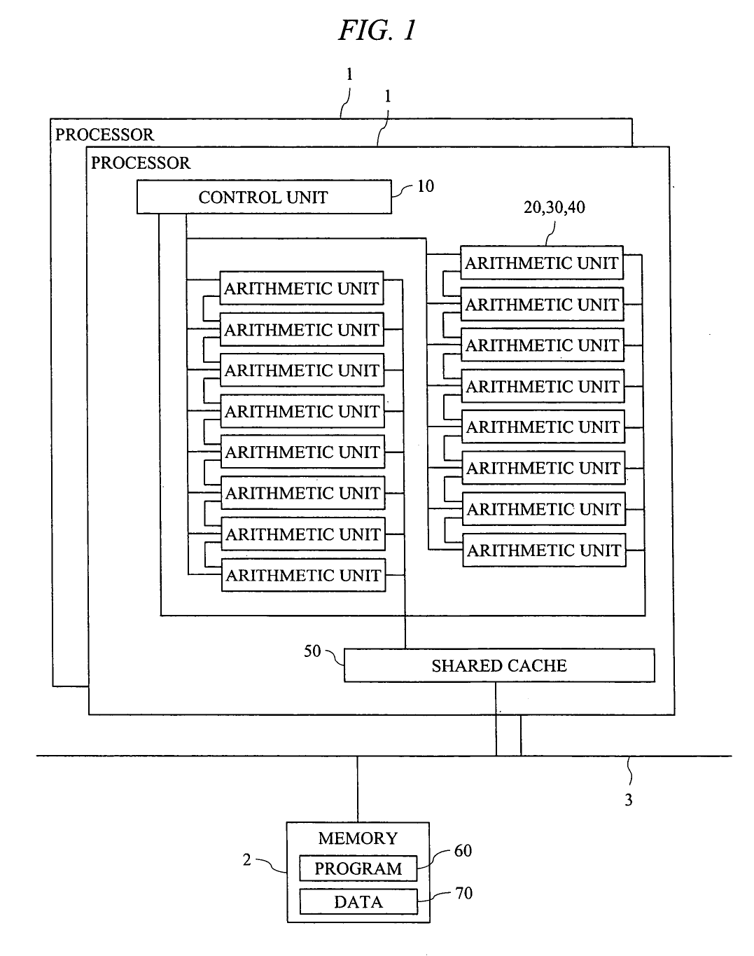

Firstly, with reference to FIG. 1, an example of a configuration of a multiprocessor system according to one embodiment of the present invention is described. FIG. 1 is a view showing an example of the configuration of the multiprocessor system.

The multiprocessor system according to the present embodiment is applied to an on-chip heterogeneous multiprocessor and includes a plurality of processors 1 and a memory 2 accessible from these processors 1, wherein the processors and the memory are connected to one another over an internal network 3.

Each processor 1 includes one control unit 10 that reads a program, a plurality of arithmetic units 20, 30, and 40 that transmits a Single Instruction Multiple Data (SIMD) instruction of the program read by the control unit 10, and a shared cache 50 having stored therein the program read by the control unit 10 from the memory 2 and allowing the control unit 10 and the plurality of arithmetic units 20, 30, and 40 to read and write data.

The memory 2 has stored therein a program 60 to be executed by each processor 1 and data 70 to be accessed in this program 60. The program 60 includes at least one program partition for control unit to be executed by the control unit 10 and at least one program partition for arithmetic unit to be executed by the arithmetic units 20, 30, and 40. The program partition for arithmetic unit is enclosed with a start code indicative of a start and an end code indicative of an end.

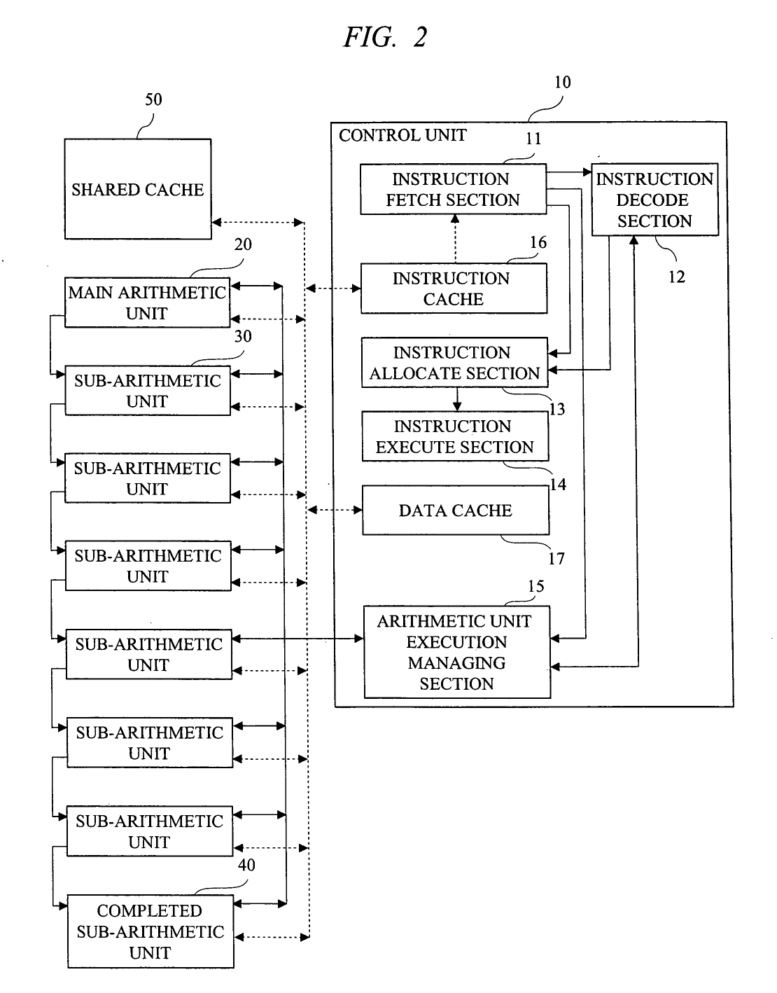

Next, with reference to FIG. 2, an example of the configuration of the above-mentioned control unit and arithmetic units is described. FIG. 2 is a view showing an example of the control unit and the arithmetic units.

The control unit 10 includes an instruction Fetch section 11, an instruction Decode section 12, an instruction Allocate section 13, an instruction Execute section 14, an arithmetic unit execution managing section 15, an instruction cache 16, and a data cache 17. Note that the instruction cache 16 and the data cache 17 can be accessed only by the control unit 10.

An instruction to be transmitted from the control unit 10 to the plurality of arithmetic units 20, 30, and 40 specifies, in a process where the plurality of arithmetic units execute instructions, whether, until receiving an external signal from an arithmetic unit different from an arithmetic unit that is executing an instruction, execution of the instruction is to be suspended. Also, when an arithmetic unit resumes a process of the instruction whose execution has been suspended, an external signal is issued to the control unit 10 or a different arithmetic unit.

Also, the control unit 10 selects whether a Cascaded execution scheme is applied to an instruction configuring the program partition for arithmetic unit, and also selects the Cascaded execution scheme for a pre-fetch instruction configuring the program partition for arithmetic unit. At this time, the instruction to be transmitted from the control unit 10 to the arithmetic units 20, 30, and 40 includes a field for being set with or without the Cascaded execution scheme.

Furthermore, the control unit 10 determines completion of the instruction, to which the Cascaded execution scheme has been applied, by receiving a complete notification from the completed sub-arithmetic units of all arithmetic unit groups. Also, when the control unit 10 specifies execution through the Cascaded execution scheme for the pre-fetch instruction, a suspension decision point is set before issuing a read request from the shared cache for data missed in the data cache of the arithmetic unit.

In the above-configured control unit 10, the instruction Fetch section 11 reads an instruction code to be next executed from the instruction cache 16. The instruction Decode section 12 decodes, from out of fetched instructions, instructions for control unit and instructions other than those dedicated to the arithmetic units but common to the control unit. The instruction Allocate section 13 allocates a resource required for instruction execution, such as a register. The instruction Execute section 14 executes an instruction. The arithmetic unit execution managing section 15 manages issuance of an instruction for arithmetic unit to each arithmetic unit and completion of execution of the instruction. Also, the arithmetic unit execution managing section 15 specifies a Cascaded execution scheme or a concurrent execution scheme with respect to an instruction for arithmetic unit for which an instruction execution scheme can be specified.

The arithmetic units 20, 30, and 40 are divided into a plurality of arithmetic unit groups. Each arithmetic unit group includes a main arithmetic unit 20, sub-arithmetic units 30, and a completed sub-arithmetic unit 40.

The arithmetic units execute a common instruction interpreted by the control unit and a dedicated instruction interpreted by the arithmetic unit. Also, in a process where the arithmetic unit executes an instruction specified by the control unit as being executed through the Cascaded execution scheme, upon reaching a suspension decision point for determining whether to be suspended, if having received a Cascaded external signal, the arithmetic unit goes to a process of execution. If having not received the Cascaded external signal, the arithmetic unit suspends the execution until receiving the Cascaded external signal.

In the above-configured arithmetic units, the main arithmetic unit 20 has a path for transmitting an external signal to one specific arithmetic unit at the time of completion of an instruction for which the Cascaded execution scheme has been specified. The sub-arithmetic units 30 each have a path for receiving, from one specific arithmetic unit, an external signal for resuming a process for a process-suspended instruction for which the Cascaded execution scheme has been specified and a path for transmitting a Cascaded external signal to one specific arithmetic unit at the time of completion of an instruction for which the Cascaded execution scheme has been specified. The completed sub-arithmetic unit 40 has a path for receiving, from one specific arithmetic unit, a Cascaded external signal for resuming a process for a process-suspended instruction for which the Cascaded execution scheme has been specified and a path for transmitting a Cascaded external signal to the control unit at the time of completion of an instruction for which the Cascaded execution scheme has been specified.

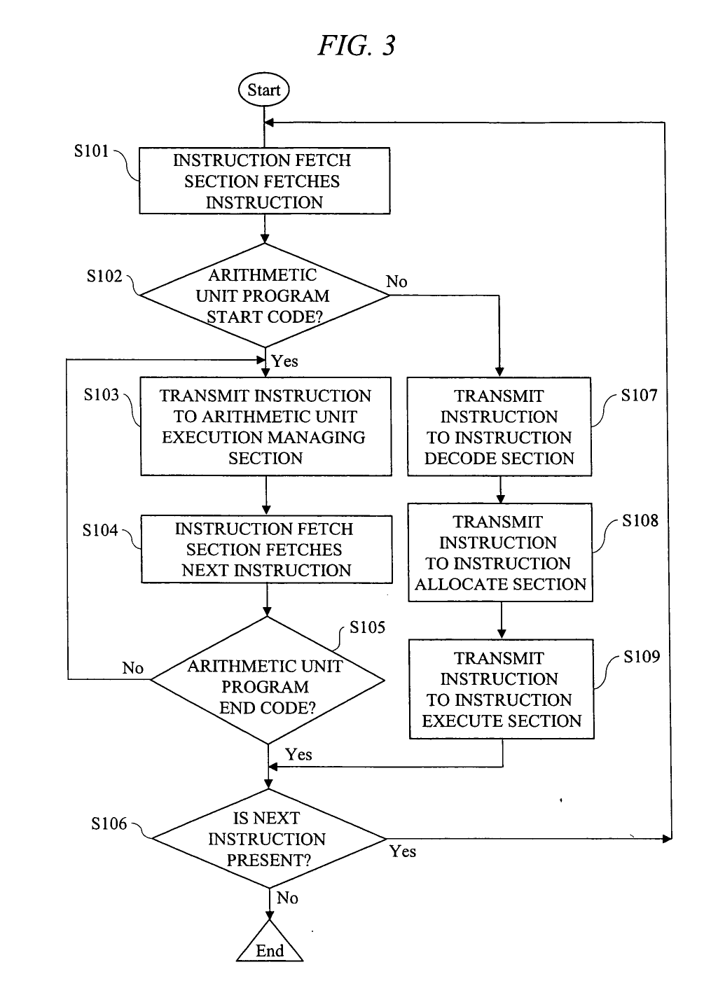

Next, with reference to FIG. 3, an example of a flow of an instruction execution process of the above-described control unit is described. FIG. 3 is a view showing an example of a flow of the instruction execution process of the control unit.

In the instruction execution process of the control unit 10, firstly, the instruction Fetch section 11 fetches an instruction (S101), and determines whether it is an arithmetic unit program start code (S102). As a result of this determination, if it is an arithmetic unit program start code (Yes), the instruction is transmitted to the arithmetic unit execution managing section 15 (S103).

Next, the instruction Fetch section 11 fetches the next instruction (S104), and determines whether it is an arithmetic unit program end code (S105). As a result of this determination, if it is an arithmetic unit program end code (Yes), it is determined whether the next instruction is present (S106). If the next instruction is not present (No), the process ends. If the next instruction is present (Yes), the process repeats the procedure from S101.

As a result of determination in S102, if the instruction is not the arithmetic unit program start code (No), the instruction is transmitted to the instruction Decode section 12 (S107), further to the instruction Allocate section 13 (S108), and then further to the instruction Execute section 14 (S109). The process then goes to S106.

In the above-described manner, the instruction execution process of the control unit 10 is performed.

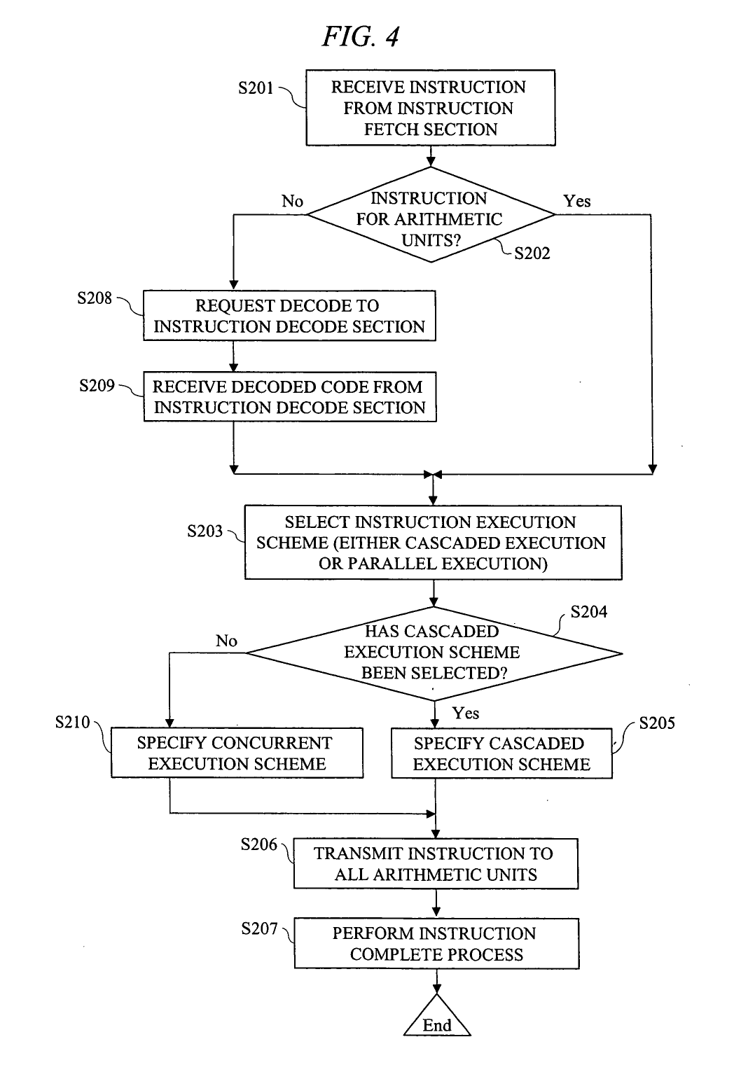

Next, with reference to FIG. 4, an example of a process flow of the above-described arithmetic unit execution managing section is described. FIG. 4 is a view showing an example of the process flow of the arithmetic unit execution managing section.

In the process of the arithmetic unit execution managing section 15, firstly, an instruction is received from the instruction Fetch section 11 (S201), and it is determined whether the instruction is an instruction dedicated to the arithmetic units (S202). As a result of the determination, if it is an instruction dedicated to the arithmetic units (Yes), an instruction execution scheme is selected (S203).

Next, in selecting an instruction execution scheme, it is determined whether the Cascaded execution scheme has been selected (S204). As a result of this determination, if the Cascaded execution scheme has been selected (Yes), the Cascaded execution scheme is specified (S205). The instructions are then transmitted to all the arithmetic units 20, 30, and 40 (S206), an instruction complete process is performed (S207), and then the process ends.

Also, as a result of the determination in S202, if the instruction is not an instruction dedicated to the arithmetic units (No), the Decode is requested to the instruction Decode section 12 (S208), the decoded code is received from the instruction Decode section 12 (S209), and then the process goes to S203.

Furthermore, as a result of the determination in S204, if the Cascaded execution scheme has not been selected (No), a parallel execution scheme is specified (S210) and the process then goes to S206.

In the above-described manner, the process of the arithmetic unit execution managing section 15 is performed.

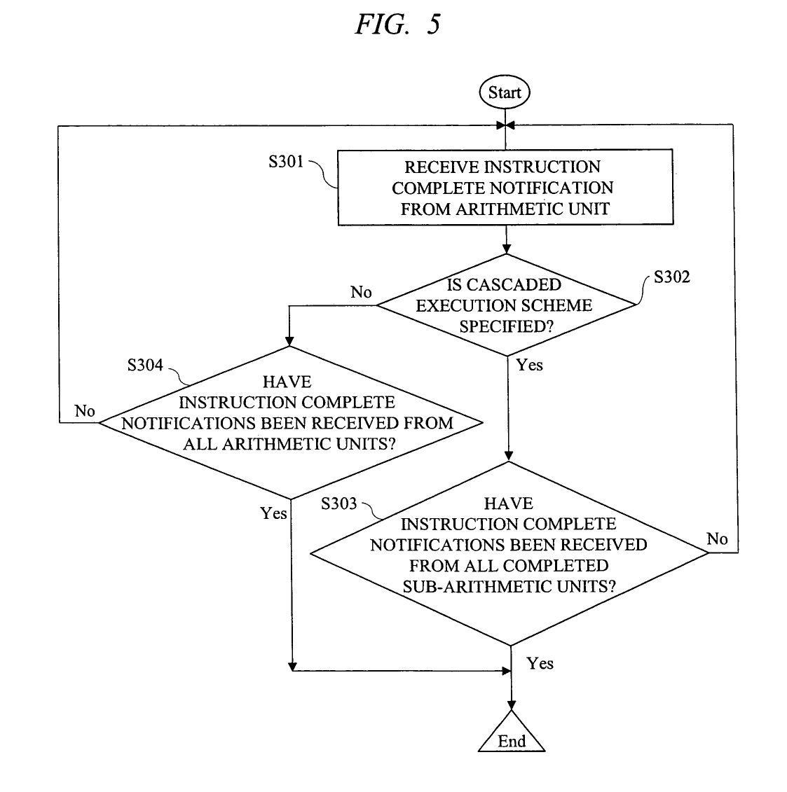

Next, with reference to FIG. 5, an example of a flow of an instruction complete process of the above-described arithmetic unit execution managing section is described. FIG. 5 is a view showing an example of the flow of the instruction complete process of the arithmetic unit execution managing section.

In the instruction complete process of the arithmetic unit execution managing section 15, firstly, an instruction complete notification is received from an arithmetic unit (S301), and it is then determined whether the Cascaded execution scheme is specified (S302). As a result of the determination, if the Cascaded execution scheme is specified (Yes), it is determined whether instruction complete notifications have been received from all the completed sub-arithmetic units 40 (S303). If they have been received (Yes), the process ends. If they have not been received (No), the process repeats the procedure from S301.

Also, as a result of the determination in S302, if the Cascaded execution scheme is not specified (No), it is determined whether instruction complete notifications have been received from all the arithmetic units 20, 30, and 40 (S304). If they have been received (Yes), the process ends. If they have not been received (No), the process repeats the procedure from S301. In the above-described manner, the instruction complete process of the arithmetic unit execution managing section 15 is performed.

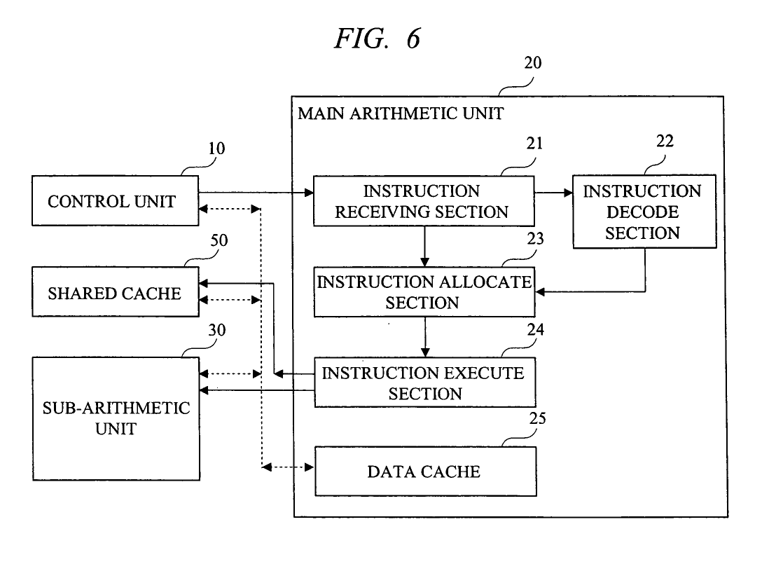

Next, with reference to FIG. 6, an example of the configuration of the above-described main arithmetic unit is described. FIG. 6 is a view showing an example of the configuration of the main arithmetic unit.

The main arithmetic unit 20 includes an instruction receiving section 21, an instruction Decode section 22, an instruction Allocate section 23, an instruction Execute section 24, and a data cache 25.

In the above-configured main arithmetic unit 20, the instruction receiving section 21 receives an instruction issued from the arithmetic unit execution managing section 15 of the control unit 10. If the received instruction is an instruction dedicated to the arithmetic units and has not yet been decoded, the Decode is requested to the instruction Decode section 22. The instruction Allocate section 23 allocates a resource required for instruction execution, such as a register. The instruction Execute section 24 executes an instruction. Also, if the Cascaded execution scheme has been specified in the instruction, the instruction Execute section 24 transmits a Cascaded external signal.

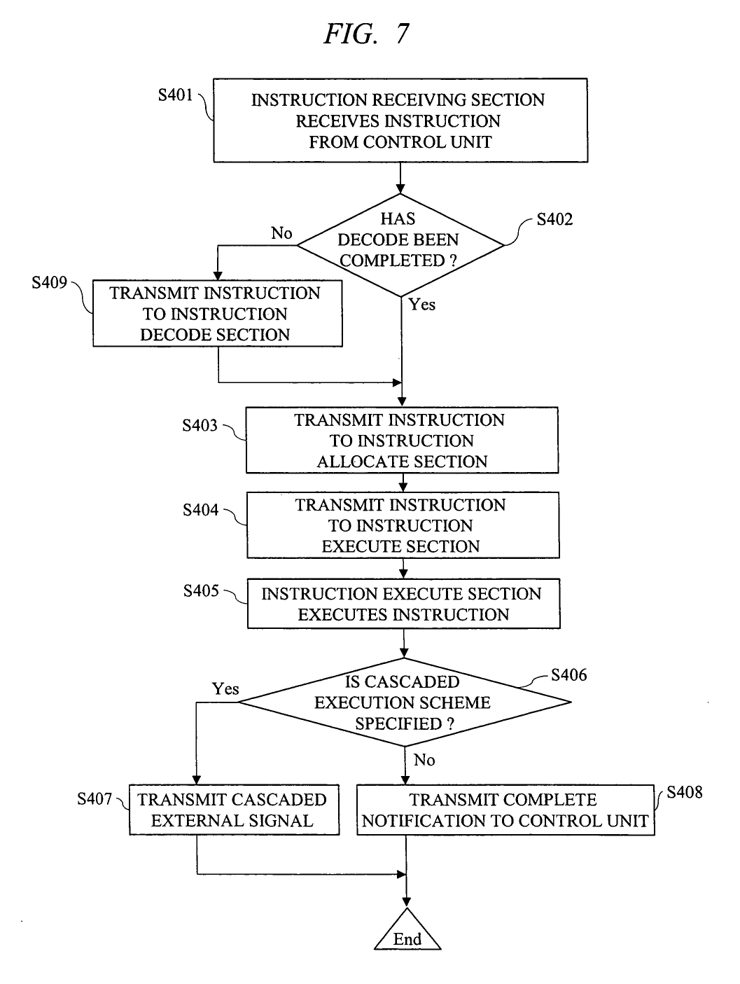

Next, with reference to FIG. 7, an example of a process flow of the above-described main arithmetic unit is described. FIG. 7 is a view showing an example of the process flow of the main arithmetic unit.

In the process of the main arithmetic unit 20, firstly, an instruction from the control unit 10 is received by the instruction receiving section 21 (S401), and it is then determined whether Decode has been completed (S402). As a result of the determination, if the Decode has been completed (Yes), the instruction is transmitted to the instruction Allocate section 23 (S403) and further to the instruction Execute section 24 (S404).

Next, the instruction is executed by the instruction Execute section 24 (S405), and it is then determined whether the Cascaded execution scheme is specified (S406). As a result of the determination, if the Cascaded execution scheme is specified (Yes), a Cascaded external signal is transmitted (S407). If the Cascaded execution scheme is not specified (No), a complete notification is transmitted to the control unit 10 (S408) and then the process ends.

Also, as a result of the determination in S402, if Decode has not been completed (No), the instruction is transmitted to the instruction Decode section 22 (S409) and the process goes to S403.

In the above-described manner, the process of the main arithmetic unit 20 is performed.

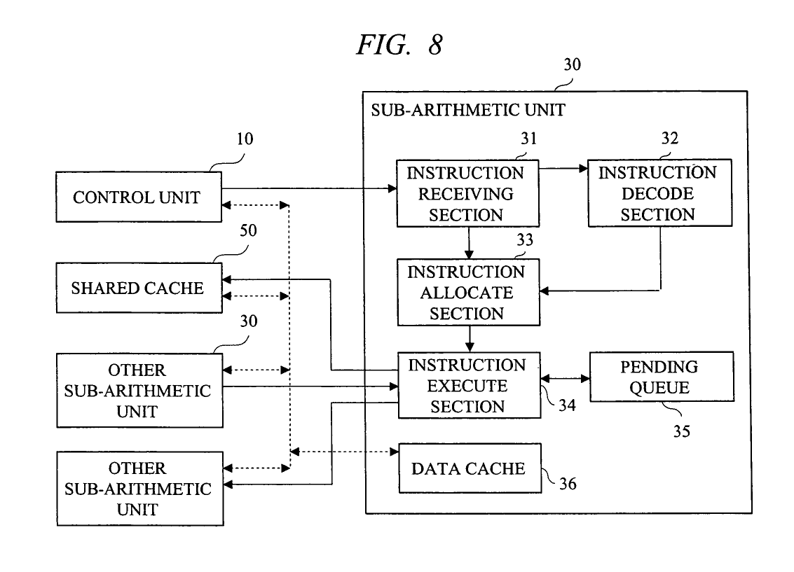

Next, with reference to FIG. 8, an example of the configuration of the above-described sub-arithmetic unit is described. FIG. 8 is a view showing the configuration of the sub- arithmetic unit.

The sub-arithmetic unit 30 includes an instruction receiving section 31, an instruction Decode section 32, an instruction Allocate section 33, an instruction Execute section 34, a Pending queue 35, and a data cache 36.

In the above-configured sub-arithmetic unit 30, the instruction receiving section 31 receives an instruction issued from the arithmetic unit execution managing section 15 of the control unit 10. If the received instruction is an instruction dedicated to the arithmetic units and has not yet been decoded, the Decode is requested to the instruction Decode section 32. The instruction Allocate section 33 allocates a resource required for instruction execution, such as a register. The instruction Execute section 34 executes an instruction. Also, if the Cascaded execution scheme has been specified in the instruction and a Cascaded external signal has not yet been received, the instruction Execute section 34 registers the instruction in the Pending queue 35. If a Cascaded external signal is received, the instruction is deleted from the Pending queue 35 to resume the execution and then the Cascaded external signal is transmitted.

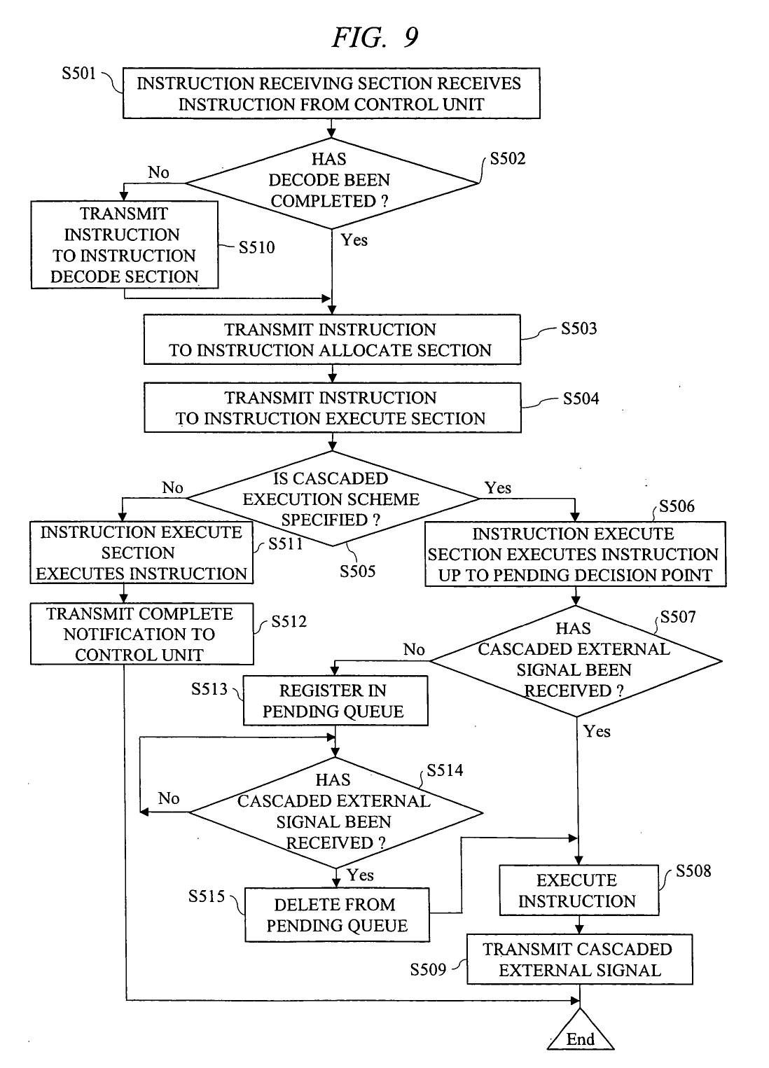

Next, with reference to FIG. 9, an example of a process flow of the above-described sub-arithmetic unit is described. FIG. 9 is a view showing an example of the process flow of the sub- arithmetic unit.

In the process of the sub-arithmetic unit 30, firstly, an instruction from the control unit 10 is received by the instruction receiving section 31 (S501), and it is then determined whether Decode has been completed (S502). As a result of the determination, if the Decode has been completed (Yes), the instruction is transmitted to the instruction Allocate section 33 (S503) and further to the instruction Execute section 34 (S504).

Next, it is determined whether the Cascaded execution scheme is specified (S505). As a result of the determination, if the Cascaded execution scheme is specified (Yes), the instruction Execute section 34 executes an instruction up to a Pending decision point (S506) and it is then determined whether a Cascaded external signal has been received (S507). As a result of the determination, if a Cascaded external signal has been received (Yes), the instruction is executed (S508) and the Cascaded external signal is transmitted (S509) and then the process ends.

Also, as a result of the determination in S502, if Decode has not been completed (No), the instruction is transmitted to the instruction Decode section 32 (S510) and the process then goes to S503.

Further, as a result of the determination in S505, if the Cascaded execution scheme is not specified (No), the instruction is executed by the instruction Execute section 34 (S511) and a complete notification is transmitted to the control unit 10 (S512) and then the process ends.

As a result of the determination in S507, if a Cascaded external signal has not been received (No), the instruction is registered in the Pending queue 35 (S513) and it is then determined whether a Cascaded external signal has been received (S514). If a Cascaded external signal has been received (Yes), the instruction is deleted from the Pending queue 35 (S515) and the process then goes to S508.

In the above-described manner, the process of the sub-arithmetic unit 30 is performed.

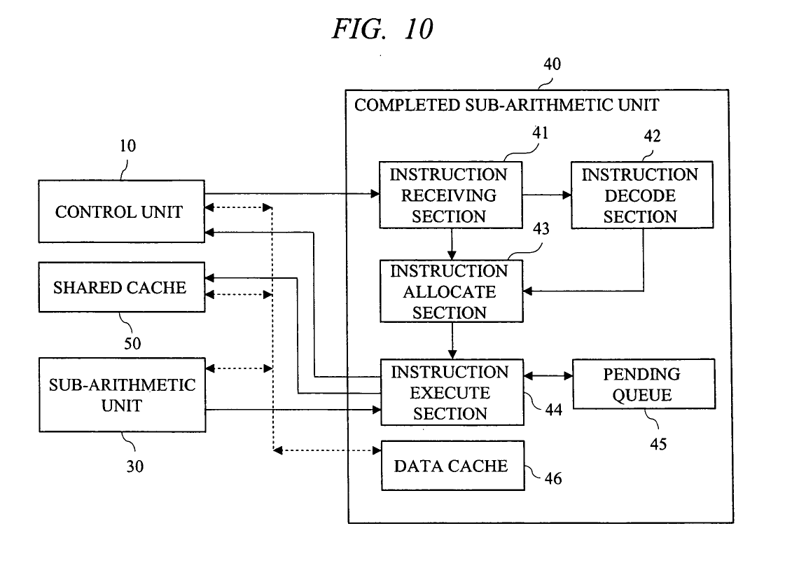

Next, with reference to FIG. 10, an example of the configuration of the above-described completed sub-arithmetic unit is described. FIG. 10 is a view showing an example of the configuration of the completed sub-arithmetic unit.

The completed sub-arithmetic unit 40 includes an instructing receiving section 41, an instruction Decode section 42, an instruction Allocate section 43, an instruction Execute section 44, a Pending queue 45, and a data cache 46.

In the above-configured sub-arithmetic unit 40, the instruction receiving section 41 receives an instruction issued from the arithmetic unit execution managing section 15 of the control unit 10. If the received instruction is an instruction dedicated to the arithmetic units and has not yet been decoded, the Decode is requested to the instruction Decode section 42. The instruction Allocate section 43 allocates a resource required for instruction execution, such as a register. The instruction Execute section 44 executes an instruction. Also, if the Cascaded execution scheme has been specified in the instruction and a Cascaded external signal has not yet been received, the instruction Execute section 44 registers the instruction in the Pending queue 45. If a Cascaded external signal is received, the instruction is deleted from the Pending queue 45 to resume the execution and then a complete notification is transmitted to the control unit 10.

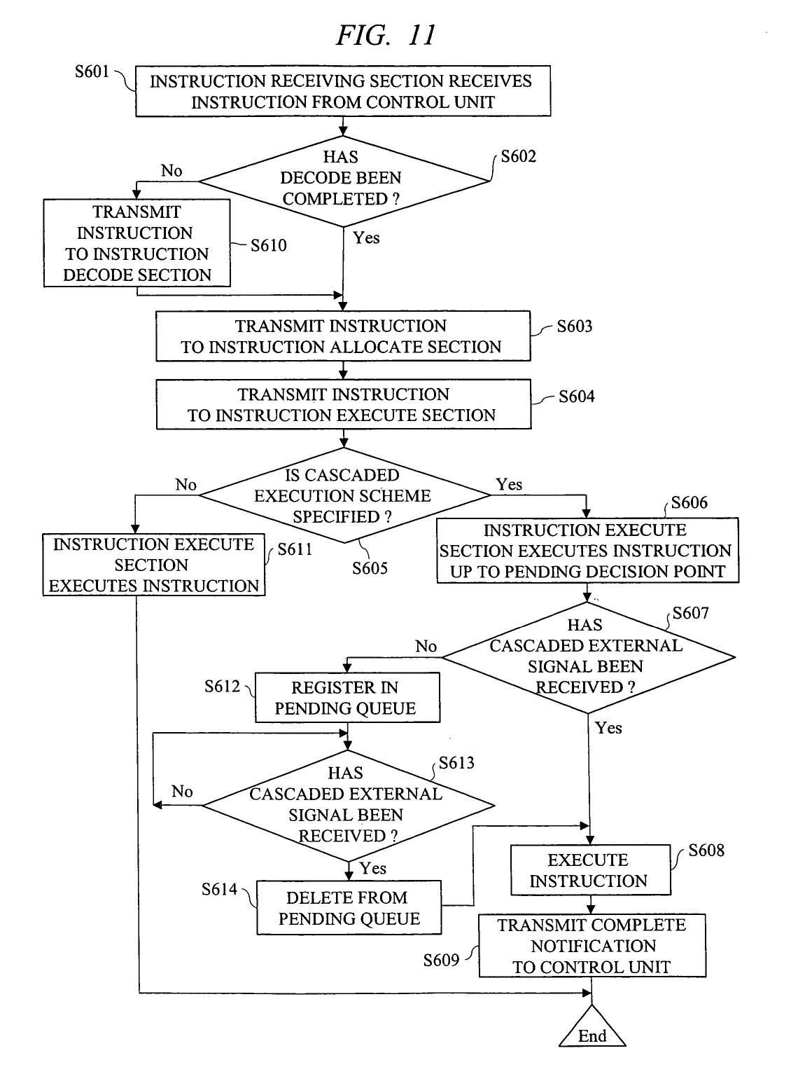

Next, with reference to FIG. 11, an example of a process flow of the above-described completed sub-arithmetic unit is described. FIG. 11 is a view showing an example of the process flow of the completed sub-arithmetic unit.

In the process of the completed sub-arithmetic unit 40, firstly, an instruction from the control unit 10 is received by the instruction receiving section 41 (S601), and it is then determined whether Decode has been completed (S602). As a result of the determination, if the Decode has been completed (Yes), the instruction is transmitted to the instruction Allocate section 43 (S603) and further to the instruction Execute section 44 (S604).

Next, it is determined whether the Cascaded execution scheme is specified (S605). As a result of the determination, if the Cascaded execution scheme is specified (Yes), the instruction Execute section 44 executes an instruction up to a Pending decision point (S606) and it is then determined whether a Cascaded external signal has been received (S607). As a result of the determination, if a Cascaded external signal has been received (Yes), the instruction is executed (S608) and a complete notification is transmitted to the control unit 10 (S609) and then the process ends.

Also, as a result of the determination in S602, if Decode has not been completed (No), the instruction is transmitted to the instruction Decode section 42 (S610) and the process then goes to S603.

Further, as a result of the determination in S605, if the Cascaded execution scheme is not specified (No), the instruction is executed by the instruction Execute section 44 (S611) and then the process ends.

As a result of the determination in S607, if a Cascaded external signal has not been received (No), the instruction is registered in the Pending queue 45 (S612) and it is then determined whether a Cascaded external signal has been received (S613). If a Cascaded external signal has been received (Yes), the instruction is deleted from the Pending queue 45 (S614) and the process then goes to S608.

In the above-described manner, the process of the completed sub-arithmetic unit 40 is performed.

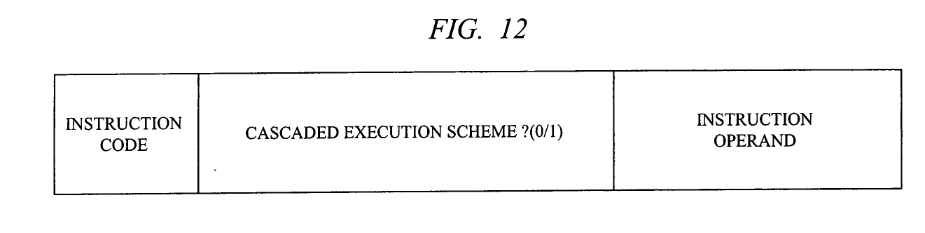

Next, with reference to FIG. 12, an example of instruction format transmitted from the above-described control unit to the arithmetic units is described. FIG. 12 is a view showing an example of the instruction format transmitted from the control unit to the arithmetic units.

The instruction format transmitted from the control unit to 10 the arithmetic units 20, 30, and 40 includes an instruction code, a Cascaded execution scheme, and an instruction operand. When the Cascaded execution scheme is indicated as “1”, the Cascaded execution scheme is performed. When the Cascaded execution scheme is indicated as “0”, a normal execution scheme is performed.

As having been described in the foregoing, according to the multiprocessor system of the present embodiment, a SIMD instruction is explicitly executed in a Cascaded shape among the processors 1, thereby making it possible to improve usability and performance of the on-chip heterogeneous multiprocessor.

As described above, the inventions made by the present inventors have be concretely described based on the embodiments. However, needless to say, the present invention is not limited to the above embodiments and may be variously altered and modified within the scope of not departing from the gist thereof.

The present invention relates to a processor system and is particularly effectively applied to an on-chip heterogeneous multiprocessor.

What is claimed is:

1. A processor system having a memory storing a program and data, a processor executing the program using the data, and an internal network connecting the memory and the processor, the processor system comprising:
a control unit reading the program;
a plurality of arithmetic units transmitting a SIMD instruction of the program read by the control unit; and
a shared cache capable of storing the program read by the control unit from the memory and allowing the control unit and the plurality of arithmetic units to read and write data,
wherein an instruction transmitted from the control unit to the plurality of arithmetic units specifies, in a process where the plurality of arithmetic units execute instructions, whether, until receiving an external signal from an arithmetic unit different from the arithmetic unit executing the instruction, execution of the instruction is to be suspended.

2. The processor system according to claim 1,
wherein when the arithmetic unit resumes a process of the instruction whose execution has been suspended, an external signal is issued to one of the control unit and the different arithmetic unit.

3. The processor system according to claim 1,
wherein the program includes at least one program partition for control unit to be executed by the control unit and at least one program partition for arithmetic unit to be executed by the arithmetic units, and
the program partition for arithmetic unit is enclosed with a start code indicative of a start and an end code indicative of an end.

4. The processor system according to claim 1,
wherein the arithmetic unit executes a common instruction interpreted by the control unit and a dedicated instruction interpreted by the arithmetic unit.

5. The processor system according to claim 3,
wherein the control unit selects whether a Cascaded execution scheme is applied to an instruction configuring the program partition for arithmetic unit.

6. The processor system according to claim 3,
wherein the control unit selects a Cascaded execution scheme for a pre-fetch instruction configuring the program partition for arithmetic unit.

7. The processor system according to claim 1,
wherein the arithmetic units are divided into a plurality of arithmetic unit groups,
each of the arithmetic unit groups includes:
a main arithmetic unit having a path for transmitting an external signal to one specific arithmetic unit at a time of completion of an instruction for which a Cascaded execution scheme has been specified;
a sub-arithmetic unit having a path for receiving, from one specific arithmetic unit, an external signal for resuming a process for a process-suspended instruction for which the Cascaded execution scheme has been specified, and a path for transmitting a Cascaded external signal to one specific arithmetic unit at a time of completion of an instruction for which the Cascaded execution scheme has been specified; and
a completed sub-arithmetic unit having a path for receiving, from one specific arithmetic unit, a Cascaded external signal for resuming a process for a process-suspended instruction for which the Cascaded execution scheme has been specified, and a path for transmitting a Cascaded external signal to the control unit at the time of completion of an instruction for which the Cascaded execution scheme has been specified.

8. The processor system according to claim 7,
wherein the instruction to be transmitted from the control unit to the arithmetic units includes a field for being set with or without the Cascaded execution scheme.

9. The processor system according to claim 7,
wherein the control unit determines completion of an instruction, to which the Cascaded execution scheme is applied, by receiving a complete notification from the completed sub-arithmetic units of all the arithmetic unit groups.

10. The processor system according to claim 7,
wherein in a process where the arithmetic unit executes an instruction specified by the control unit as executed through the Cascaded execution scheme, at a time of reaching a suspension decision point for determining whether to be suspended, if having received the Cascaded external signal, the arithmetic unit goes to a process of execution and if not having received the Cascaded external signal, the arithmetic unit suspends execution until receiving the Cascaded external signal.

11. The processor system according to claim 10,
wherein when the control unit specifies execution through the Cascaded execution scheme for a pre-fetch instruction, the suspension decision point is set before issuing a read request from the shared cache for data missed in the data cache of the arithmetic unit.
